(19) United States
(12) Patent Application Publication
(10) Pub. No.: US 2009/0193332 A1
(43) Pub. Date: Jul. 30, 2009

(54) METHOD AND APPARATUS FOR EDITING LETTERS

(75) Inventor: Jae-Gap LEE, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/358,621

(22) Filed: Jan. 23, 2009

(30) Foreign Application Priority Data
Jan. 28, 2008 (KR) 2008-8633

(51) Int. Cl. G06F 17/00; G06F 3/048; G06F 7/06; G06F 17/30

(52) U.S. Cl. 715/256; 715/816; 707/1; 707/E17.044; 707/E17.014

(57) ABSTRACT

A method and apparatus for editing letters in which letters are conveniently edited through use of an autocomplete operation after input of a backspace operation, the method including: deleting at least one letter by a backspace operation that moves a cursor one position backwards and deletes a preceding letter; storing the at least one deleted letter; displaying, when a letter is re-input at the position where the at least one letter was deleted, a stored phrase that includes the re-input letter; and replacing the re-input letter with the displayed phrase when the displayed phrase is selected.

### CROSS-REFERENCE TO RELATED APPLICATION

This application claims the benefit of Korean Patent Application No. 2008-8633, filed Jan. 28, 2008 in the Korean Intellectual Property Office, the disclosure of which is incorporated herein by reference.

### BACKGROUND OF THE INVENTION

1. Field of the Invention

Aspects of the present invention relate to a method and apparatus for editing letters, and, more particularly, to a method and apparatus for editing letters in which letters are conveniently edited through use of an autocomplete operation after operation of a backspace key.

2. Description of the Related Art

To delete letters that have been incorrectly input in a document editor (such as a word processor), the user generally uses the backspace key that moves the cursor one position, deletes a preceding character, and shifts back the text after the deleted character by one position. The position of the backspace key on an English or Korean keyboard layout is typically close enough so that the user can press the backspace key without having to lift his or her hands from a normal typing position.

As an example, it is assumed that the user has typed “the text nust be corrected_” in the document editor, where “_” indicates the present location of the cursor. Typically, the realization that a mistake has been made does not occur immediately after the mistake is made, but sometime later. That is, in the above phrase, the user typically does not realize that a mistake has been made as soon as “the text n” has been typed, but rather only after, for example, the entire phrase has been input (namely, at the location of the cursor in “the text nust be corrected_”). In this case, most users press the backspace key 17 times until only “the text_” is remaining in this phrase. Subsequently, the user types “must be corrected” to fix the error and complete the phrase in the correct manner as “the text must be corrected_.”

During the above process, the backspace key functions simply to delete letters. Therefore, when one letter is incorrect in a sentence or phrase and the backspace key is pressed until the incorrect letter is deleted, all of the letters subsequent to the incorrect letter must be retyped, which is inconvenient.

It is possible to correct mistyped letters by pressing the arrow keys until reaching the error, after which only the incorrect letter is corrected. However, the positioning of the arrow keys on English and Korean keyboard layouts is such that the user must lift his or her hands from the normal typing position to operate the arrow keys, which is inconvenient. Furthermore, after the error has been corrected, the cursor must again position back to the original position by manipulating the arrow keys a second time. The user must again lift his or her hand from the normal typing position during such an operation.

Hence, the drawback of using the backspace key to perform letter editing is that all letters subsequent to the incorrect letter are also deleted. Moreover, the drawback of using the arrow keys to correct an error is that when moving the cursor to the position of the error and then back to the original position after the correction has been made, the user must lift his or her hands to operate the arrow keys due to the inconvenient positioning of the same on most keyboard layouts as described above.

### SUMMARY OF THE INVENTION

Aspects of the present invention provide a method and apparatus for editing letters in which letters are conveniently edited through use of an autocomplete operation after input of a backspace key.

According to an aspect of the present invention, there is provided a method of editing letters input through an input unit and displayed on a display, the method including: deleting at least one letter by a backspace operation that moves a cursor one position backwards and deletes a preceding letter; storing the at least one deleted letter; displaying, when a letter is re-input at a position where the at least one letter was deleted, a stored phrase that includes the re-input letter; and replacing the re-input letter with the displayed phrase when the displayed phrase is selected.

According to another aspect of the present invention, there is provided an apparatus for editing letters, the apparatus including: an input unit to input letters and to input a backspace that moves a cursor one position backwards and deletes a preceding letter; a display to display the letters input through the input unit; and a controller to store at least one letter deleted by the backspace input, to display, when a letter is re-input at a position where the at least one letter was deleted, a stored phrase that includes the re-input letter, and to replace the re-input letter with the displayed phrase when the displayed phrase is selected.

According to yet another aspect of the present invention, there is provided a method of editing letters input through an input unit of a portable device and displayed on a display of the portable device, the method including: deleting at least one letter by a backspace operation; displaying, when a letter is re-input at a position where the at least one letter was deleted, a phrase that includes the re-input letter; and replacing the re-input letter with the displayed phrase when the displayed phrase is selected.

According to still another aspect of the present invention, there is provided a method of editing letters input through an input unit and displayed on a display, the method including: deleting at least one letter by a backspace operation; storing the at least one deleted letter; and displaying, when a letter is re-input at a position where the at least one letter was deleted, a stored phrase that includes the re-input letter.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus for editing letters according to an embodiment of the present invention;

FIG. 2 is a flow chart of a method of editing letters according to an embodiment of the present invention; and

FIGS. 3 to 5 illustrate specific examples of the method of editing letters according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention are described hereinafter with reference to block diagrams and flowchart illustrations. It will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create methods for implementing the operations specified in the flowchart block or blocks. These computer program instructions may also be stored in a computer-usable or computer-readable memory that can direct a computer or other programmable data processing apparatus to operate in a particular manner, such that the instructions stored in the computer-usable or computer-readable memory produce an article of manufacture including instructions that implement the operation(s) specified in the flowchart block or blocks. The computer program instructions may also be loaded into a computer or other programmable data processing apparatus to cause a series of operational steps to be performed in the computer or other programmable apparatus to produce a computer implemented process such that the instructions that execute on the computer or other programmable apparatus provide methods for implementing the operations specified in the flowchart block or blocks. And each block of the flowchart illustrations may represent a module, segment, or portion of code, which includes one or more executable instructions for implementing the specified logical operation(s). It should also be noted that in some alternative implementations, the operations noted in the blocks may occur out of order. For example, two blocks shown in succession may in fact be executed substantially concurrently or the blocks may sometimes be executed in the reverse order, depending upon the functionality involved.

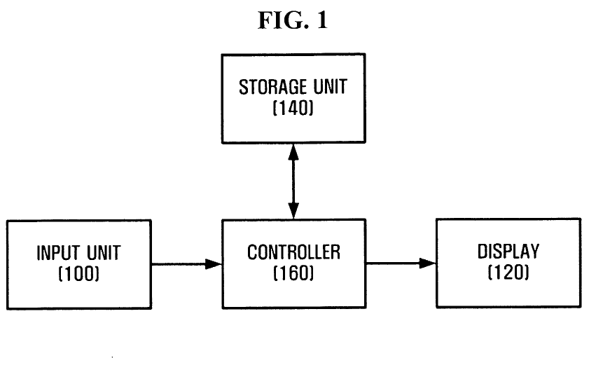

FIG. 1 is a block diagram of an apparatus for editing letters according to an embodiment of the present invention. The apparatus for editing letters shown in FIG. 1 may be a computer, a mobile phone, or a PDA (Personal Digital Assistant) capable of editing letters. However, aspects of the present invention are not limited to these examples. “Letters” as used herein refer to actual letters or characters of a writing system (such as an alphabet), as well as numbers, symbols, and/or combinations thereof. Furthermore, “phrase” as used herein, in addition to the normal meaning of a combination of two or more words in which each word is a combination of letters, may also be used to refer to a single word, a string of alphanumeric characters such as in an e-mail address or a web address, and a string of only numbers such as a cell phone number.

Referring to FIG. 1, the apparatus for editing letters includes an input unit 100, a display 120, a storage unit 140, and a controller 160. The input unit 100 includes a keypad having a plurality of keys associated with letters, numbers, and/or symbols (hereinafter referred to simply as “letters”) and a plurality of operational keys for performing various operations. One of the operational keys is a backspace key that moves a cursor one position backwards, deletes a preceding character, and shifts back the text after the deleted character by one position each time the backspace key is pressed. The input unit 100, in addition to a keypad, may be or include any device that allow for a user input of letters, numbers, and/or symbols (such as a touchscreen). That is, it is understood that the input unit 100 may be any input device that includes a backspace key (or other device that operates as the backspace key operates) according to aspects of the present invention.

Furthermore, the input unit 100 may additionally include a key to activate an autocomplete operation. The “autocomplete operation” as used herein refers to an operation that conveniently helps the user perform inputs, and operates as follows. When the user begins to input a word or sentence, information of what has been input so far and information of words and sentences previously input by the user are used to infer what the user intends to input and displays valid candidates in a menu format and/or automatically types out the strongest valid candidates. The user is able to activate the autocomplete operation through the input unit 100. That is, using the abovementioned key, the user is able to display an autocomplete operation activation menu. If this is done, the autocomplete operation activation menu is displayed to include autocomplete operation activation and cancel instructions. If the user desires to activate the autocomplete operation, then the user selects the activation instruction. Conversely, if the user desires to cancel the autocomplete operation, the user selects the cancel instruction. It is understood that aspects of the present invention are not limited thereto. For example, it is possible, as an alternative, to activate or cancel the autocomplete operation by operating the key to on and off states. As yet another alternative, the autocomplete operation may always be turned on such that the user is not required to perform any activation operation.

The input unit 100 generates key data corresponding to user operation of the keys, and transmits the key data to the controller 160. The display 120, through a control by the controller 160, displays the key data input through the input unit 100. Moreover, the display 120 may display a state of the apparatus and/or processing stages of an operating algorithm thereof. The display 120 may be a Liquid Crystal Display (LCD), a Plasma Display Panel (PDP), a Cathode-Ray Tube (CRT), or an Organic Electro Luminescent (EL) Display. However, aspects of the present invention are not limited in this respect. The input unit 100 and the display 120 may or may not be physically separated from each other. For example, a touchscreen that includes a touch panel and a display may be used such that the input unit 100 and the display 120 are combined into a single device.

The storage unit 140 stores programs for the operation of the controller 160 and data processed during operation of the controller 160. Furthermore, the storage unit 140 stores letters input by the user or deleted by the backspace key. Letters input by the user or deleted by the backspace key as used herein may be letters that are deleted by the backspace key when using document editing devices or programs (such as a word processor), letters that are deleted using the backspace key in a text message or e-mail message, letters deleted using the backspace key in an e-mail address or Uniform Resource Locator (URL), or letters that are deleted by the backspace key in a phone number that is input to make a call or send a message from a mobile phone. However, aspects of the present invention are not limited in this respect. To realize the above operations, the storage unit 140 may include an element such as a ROM (Read Only Memory), RAM (Random Access Memory), a flash memory, and/or a buffer. While the letters input by the user or deleted using the backspace key may be stored in a buffer and directly deleted after using the autocomplete operation, it is understood that aspects of the present invention are not limited in this regard.

If the backspace key is operated by the user in a state where the autocomplete operation is activated, the controller 160 may operate to store letters deleted by the backspace key in the storage unit 140. Furthermore, when a letter is input by the user after the backspace key has been operated, the controller 160 determines whether a phrase containing the letter is present in the storage unit 140. If it is determined by the controller 160 that a phrase containing the input letter is present in the storage unit 140, the controller 160 controls to display the phrase on the display 120. In addition, if the displayed phrase is selected by the user, the controller 160 controls to replace what has been input thus far with the selected phrase. In the case where there are two or more phrases that contain the input letter present in the storage unit 140, the controller 160 may control to display the phrases in a list format. The user may then select the desired phrase using, for example, the arrow and enter keys.

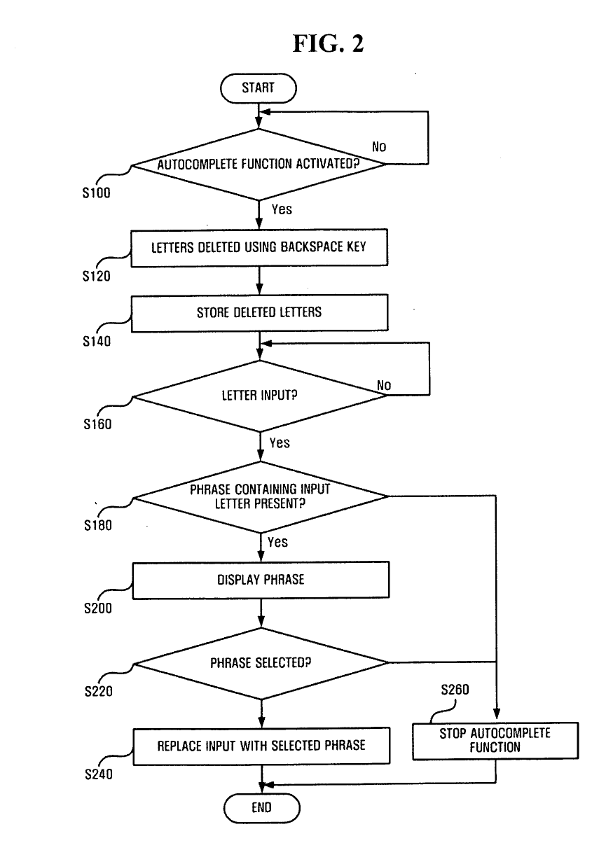

FIG. 2 is a flow chart of a method of editing letters according to an embodiment of the present invention. In a state where the autocomplete operation is activated, if the user operates the backspace key, letters deleted by the backspace key are stored in the storage unit 140 through control of the controller 160 in operations S100, S120, and S140.

Subsequently, if the user again inputs a letter(s) in operation S160, the controller 160 determines whether a phrase containing the input letter(s) is present in the storage unit 140 in step S180. If a phrase containing the letter(s) input by the user is present in the storage unit 140, the phrase is displayed on the display 120 in operation S200. If, however, there is no phrase containing the letter(s) input by the user present in the storage unit 140, the autocomplete operation is not operated in operation S260. Furthermore, if there are two or more phrases that contain the input letter(s), the controller 120 controls to display the phrases in a list format on the display 120 in operation S200.

If the user selects the displayed phrase in operation S220, the controller 160 controls to replace the letter(s) that has been input thus far with the selected phrase in operation S240. The enter key, the tab key, and or an arrow key may be operated to select the displayed phrase. However, aspects of the present invention are not limited in this regard. It is also possible for the user to not select a displayed phrase. For example, when a phrase containing the input letter(s) is displayed on the display 120 in operation S200, if the user types in the input letter(s) him or herself, or if another key (such as the ESC key) is pressed, the controller 160 determines that the user does not desire to use the autocomplete operation and therefore stops the autocomplete operation in operation S260.

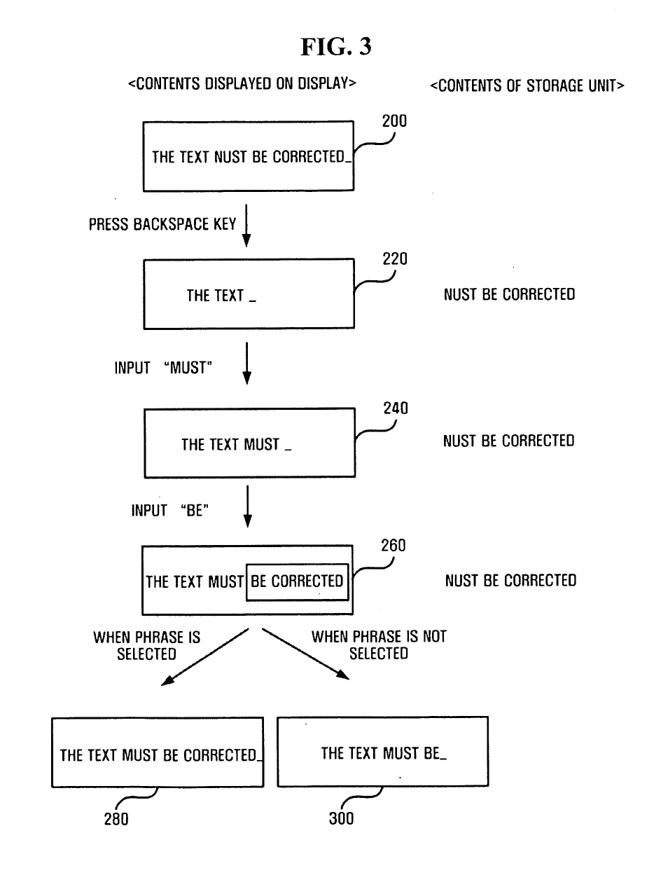

Specific examples of the above method will now be described with reference to FIGS. 3 to 5. FIG. 3 illustrates a specific example of a method of editing letters according to an embodiment of the present invention. The example shown is that in which letters are edited in a document editing device or program (such as a word processor, in a text message, an e-mail message, etc.). In FIG. 3, it is assumed for purposes of describing aspects of the present invention that the user has input the phrase “the text nust be corrected_” at block 200, where “_” indicates the present location of the cursor.

Referring to FIG. 3, if the user deletes “nust be corrected” by operating the backspace key, the storage unit 140 stores “nust be corrected” such that only “the text_” remains displayed on the display 120 at block 220. If the user then inputs “must,” the controller 160 determines if a phrase containing “must” is present in the storage unit 140. Since no phrase containing “must” is present in the storage unit 140 in this example, the autocomplete operation is not operated. Hence, “the text must_” is displayed at block 240.

If the user subsequently inputs “be,” the controller 160 determines whether a phrase containing “be” is present in the storage unit 140. If the controller 160 determines that there is a phrase containing “be” in the storage unit 140, the phrase starting with “be” (in this example, the phrase “be corrected”) is displayed on the display 120. Hence, in this example, the entire correct phrase of “the text must be corrected” is displayed at block 260.

The phrase “be corrected” that is displayed through the autocomplete operation may appear in a shaded or highlighted block as shown in FIG. 3. However, aspects of the present invention are not limited in this respect. For example, the phrase may not be distinguished, or may be displayed having a different color from that of the entered text. Furthermore, if two or more phrases containing the letters “be” are present, the phrases may appear in a drop-down menu format for selection of the desired phrase by the user.

If the user desires to input “be corrected” displayed in the shaded block, he or she may press the enter or tab key so that auto completion of these words is completed at block 280. When such auto completion is realized, “be corrected” is deleted from the storage unit 140. In contrast, if the user directly types “be” in the phrase “be corrected” in the shaded block or presses, for example, the ESC key, the controller 160 determines that the user does not desire to use the autocomplete operation, and deletes the phrase “be corrected” from the storage unit 140. Hence, the phrase “the text must be_” is displayed on the display 120 at block 300.

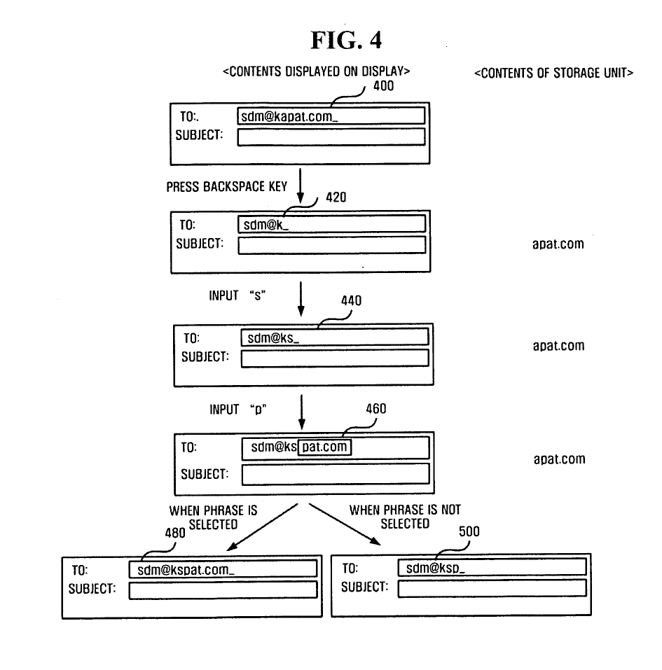

FIG. 4 illustrates another specific example of a method of editing letters according to an embodiment of the present invention. The example shown is that in which an e-mail address in the “To:” field of an e-mail message is edited. It is understood that the same process may be used to edit letters in a web address in the address bar of a web browser.

Referring to FIG. 4, a mail client program (such as Outlook Express) is started in order to send an e-mail, and an e-mail address of the desired recipient is typed in the “To:” field. It is assumed for purposes of describing aspects of the present invention that “sdm@kapat.com_” has been input at block 400, where “_” indicates the present location of the cursor and “sdm@kspat.com_” is the e-mail address when correctly typed.

If the user deletes “apat.com” by operating the backspace key, “apat.com” is stored in the storage unit 140. As a result, only “sdm@k_” remains displayed in the “To:” field at block 420. If the user then inputs the letter “s,” the controller 160 determines if a phrase containing “s” is present in the storage unit 140. Since no phrase containing “s” is present in the storage unit 140, the autocomplete operation is not operated. Hence, “sdm@ks_” is displayed at block 440.

Next, if the user inputs the letter “p,” the controller 160 determines whether a phrase containing “p” is present in the storage unit 140. If the controller 160 determines that there is a phrase containing “p” present in the storage unit 140, the phrase starting with “p” (in this example, the string of characters “pat.com”) is displayed on the display 120. Hence, in this example, the entire correct phrase of “sdm@kspat.com_” is displayed on the display 120 at block 460. At this time, the phrase “pat.com” may appear in a shaded block as shown in FIG. 4. Further, if there are two or more phrases containing the letter “p” present, the phrases may appear in a drop-down menu format.

If the user desires to input “pat.com” displayed in the shaded block, the user may press, for example, the enter or tab key so that auto completion is effected at block 480. When such auto completion is realized, “apat.com” is deleted from the storage unit 140. In contrast, if the user directly types “p” in the phrase “pat.com” in the shaded block or presses, for example, the ESC key, the controller 160 determines that the user does not desire to use the autocomplete operation, and deletes the phrase “apat.com” from the storage unit 140. Hence, the phrase “sdm@ksp_” is displayed on the display 120 at block 500.

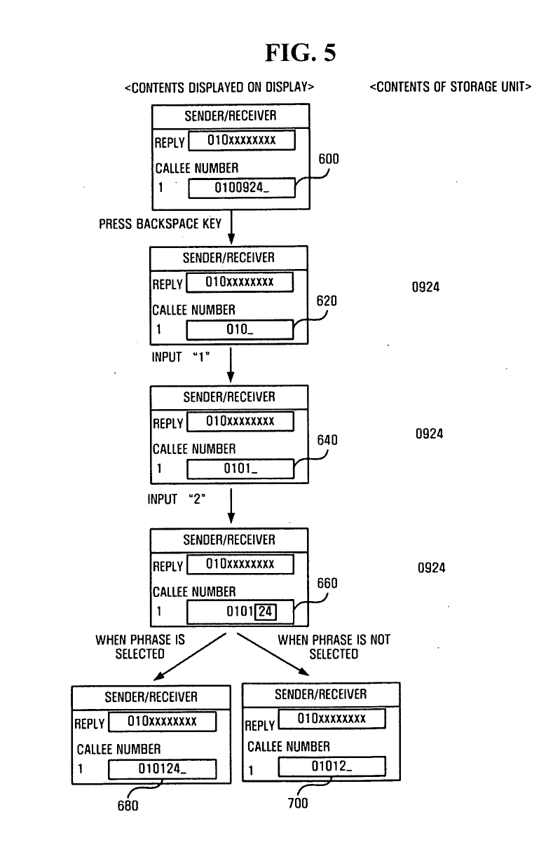

In addition to the examples described above, the same method may be used with respect to a phone number that is input in a mobile phone to make a call or send a message. FIG. 5 illustrates yet another specific example of a method of editing letters according to an embodiment of the present invention. The example shown is that in which a phone number is edited when sending a text message.

When the user prepares a text message and desires to send the text message after entering the phone number of the callee, the apparatus for editing letters (such as a mobile phone) provides a screen similar to that shown in FIG. 5. For example, if the user inputs the phrase “0100924” in the callee number input box at block 600, and “0924” is deleted using the backspace key, only “010_” remains displayed on the display 120 at block 620 and “0924” is stored in the storage unit 140.

If the user then inputs “1,” the controller 160 determines if a phrase containing “1” is present in the storage unit 140. Since no phrase containing “1” is present in the storage unit 140 in this example, the autocomplete function is not operated. Hence, “0101_” is displayed at block 640. If the user subsequently inputs “2,” the controller 160 determines whether a phrase containing “2” is present in the storage unit 140. If the controller 160 determines that there is a phrase containing “2” in the storage unit 140, the phrase starting with “2” (i.e., “24” in this example) is displayed on the display 120 at block 260. In this case, if there are two or more phrases containing the number “2,” the phrases may appear in a drop-down menu format.

If the user desires to input “24” displayed in the shaded block, the user may press, for example, the enter or tab key so that auto completion is completed at block 680. When such auto completion is realized, “0924” is deleted from the storage unit 140. In contrast, if the user directly types “2” in the phrase “24” in the shaded block or presses, for example, the ESC key, the controller 160 determines that the user does not desire to use the autocomplete operation, and deletes the phrase “0924” from the storage unit 140. Hence, the phrase “01012_” is displayed on the display 120 at block 700.

As described above, according to aspects of the present invention, letters may be conveniently edited through use of an autocomplete operation after operation of the backspace key.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of editing letters input through an input unit and displayed on a display, the method comprising:
deleting at least one letter by a backspace operation;
storing the at least one deleted letter;
displaying, when a letter is re-input at a position where the at least one letter was deleted, a stored phrase that includes the re-input letter; and
replacing the re-input letter with the displayed phrase when the displayed phrase is selected.

2. The method as claimed in claim 1, wherein for each of the at least one deleted letter, the backspace operation moves a cursor one position backwards to delete a preceding letter.

3. The method as claimed in claim 1, wherein the storing of the at least one deleted letter, the displaying of the stored phrase, and the replacing of the re-input letter with the selected displayed phrase are performed when an autocomplete operation is activated.

4. The method as claimed in claim 1, wherein:
the displaying of the stored phrase comprises displaying two or more stored phrases that include the re-input letter; and
the replacing of the re-input letter with the selected displayed phrase comprises replacing the re-input letter with the phrase selected from the two or more displayed phrases.

5. The method as claimed in claim 4, wherein the displaying of the two or more stored phrases comprises displaying the two or more stored phrases in a drop-down menu.

6. The method as claimed in claim 1, further comprising deleting the at least one stored letter when the re-input letter is replaced with the selected displayed phrase.

7. The method as claimed in claim 1, further comprising deleting the at least one stored letter when the displayed phrase is not selected.

8. The method as claimed in claim 7, wherein the deleting of the at least one stored letter when the displayed phrase is not selected comprises determining that the displayed phrase is not selected when another letter is input after the re-input letter by a user or a predetermined key is pressed by the user.

9. The method as claimed in claim 8, wherein the predetermined key is an Escape key.

10. The method as claimed in claim 1, wherein the displayed phrase is selected using an enter key and/or a tab key.

11. The method as claimed in claim 1, wherein the displaying of the stored phrase comprises displaying the stored phrase in a shaded block.

12. A computer readable recording medium encoded with the method of claim 1 and implemented by a computer.

13. An apparatus for editing letters, the apparatus comprising:
an input unit to input letters and to input a backspace that deletes at least one letter;
a display to display the letters input through the input unit; and
a controller to store the at least one deleted letter, to display, when a letter is re-input at a position where the at least one letter was deleted, a stored phrase if the stored phrase includes the re-input letter, and to replace the re-input letter with the displayed phrase when the displayed phrase is selected.

14. The apparatus as claimed in claim 13, wherein for each of the at least one deleted letter, the input backspace moves a cursor one position backwards to delete a preceding letter.

15. The apparatus as claimed in claim 13, further comprising a storage unit to store the at least one deleted letter.

16. The apparatus as claimed in claim 13, wherein:
an autocomplete operation is activated through the input unit; and
when the autocomplete function is activated, the controller stores the at least one letter deleted by the input backspace, displays the stored phrase that includes the re-input letter, and replaces the re-input letter with the displayed phrase when the displayed phrase is selected.

17. The apparatus as claimed in claim 16, wherein the autocomplete operation is activated when the backspace is input through the input unit.

18. The apparatus as claimed in claim 13, the controller displays on the display two or more stored phrases that include the re-input letter, and replaces the re-input letter with the phrase selected from the two or more stored phrases.

19. The apparatus as claimed in claim 18, wherein the controller displays on the display the two or more stored phrases in a drop-down menu.

20. The apparatus as claimed in claim 13, wherein the controller deletes the at least one stored letter when the re-input letter is replaced with the selected displayed phrase.

21. The apparatus as claimed in claim 13, wherein the controller deletes the at least one stored letter when the displayed phrase is not selected.

22. The apparatus as claimed in claim 21, wherein the controller determines that the displayed phrase is not selected when another letter is input after the re-input letter by a user or a predetermined key on the input unit is pressed by the user.

23. The apparatus as claimed in claim 22, wherein the predetermined key is an Escape key.

24. The apparatus as claimed in claim 13, wherein the input unit includes an enter key and/or a tab key, and the displayed phrase is selected using the enter key and/or the tab key.

25. The apparatus as claimed in claim 13, wherein the displayed phrase is displayed in a shaded block.

26. A method of editing letters input through an input unit of a portable device and displayed on a display of the portable device, the method comprising:
deleting at least one letter by a backspace operation;
displaying, when a letter is re-input at a position where the at least one letter was deleted, a phrase that includes the re-input letter; and
replacing the re-input letter with the displayed phrase when the displayed phrase is selected.

27. The method as claimed in claim 26, wherein:
the displaying of the phrase comprises displaying two or more phrases that include the re-input letter; and
the replacing of the re-input letter with the selected displayed phrase comprises replacing the re-input letter with the phrase selected from the two or more displayed phrases.

28. The method as claimed in claim 26, further comprising determining that the displayed phrase is not selected when another letter is input after the re-input letter.

29. The method as claimed in claim 28, further comprising stopping a display of the phrase when the displayed phrase is determined to not be selected.

30. A computer readable recording medium encoded with the method of claim 26 and implemented by a computer.

31. A method of editing letters input through an input unit and displayed on a display, the method comprising:
deleting at least one letter by a backspace operation;
storing the at least one deleted letter; and
displaying, when a letter is re-input at a position where the at least one letter was deleted, a stored phrase that includes the re-input letter.

32. A computer readable recording medium encoded with the method of claim 31 and implemented by a computer.
